(19) United States
(12) Patent Application Publication
(10) Pub. No.: US 2025/0309358 A1
(43) Pub. Date: Oct. 2, 2025

(54) LITHIUM METAL SECONDARY BATTERY

(71) Applicant: HONDA MOTOR CO., LTD., Tokyo (JP)

(72) Inventors: Tomohiro KINOSHITA, Saitama (JP); Nao YOSHINAGA, Saitama (JP)

(21) Appl. No.: 19/056,764

(22) Filed: Feb. 19, 2025

(30) Foreign Application Priority Data
Mar. 28, 2024 (JP) 2024-053709

(51) Int. Cl. H01M 10/0583; H01M 10/052; H01M 10/42; H01M 50/105; H01M 50/449; H01M 50/46; H01M 50/586; H01M 50/59

(52) U.S. Cl. CPC H01M 10/0583; H01M 10/052; H01M 10/4235; H01M 50/105; H01M 50/449; H01M 50/46; H01M 50/586; H01M 50/59

(57) ABSTRACT

Provided is a lithium metal secondary battery that is able to suppress short circuit in a lithium metal secondary battery using a separator having electrical conductivity. A lithium metal secondary battery includes an electrode laminate in which positive electrodes and negative electrode containing lithium metal are laminated with a separator interposed therebetween, and an electrolytic solution. The separator provided between the positive electrodes and the negative electrodes is folded in zigzag manner and is continuous. The lithium metal secondary battery further includes a fixing portion that fixes the separator on an outer peripheral side of the electrode laminate. The separator includes an electrically conductive layer having electric conductivity and an insulating layer having an electrical insulation property. Each of the negative electrodes is in contact with the electrically conductive layer. Each of the positive electrodes are opposed to the insulating layer.

This application is based on and claims the benefit of priority from Japanese Patent Application No. 2024-053709, filed on 28 Mar. 2024, the content of which is incorporated herein by reference.

### BACKGROUND OF THE INVENTION

### Field of the Invention

The present invention relates to a lithium metal secondary battery.

### Related Art

In recent years, research and development have been conducted on batteries that contribute to energy efficiency to ensure that more people have access to affordable, reliable, sustainable, and advanced energy.

For example, a battery structure having a laminate has been known in which a separator is disposed between a positive electrode and a negative electrode. The laminate is accommodated in a laminate film. As such a battery structure, a battery structure having a structure in which a long continuous separator film is used and folded in a certain unit size has been disclosed (Korean Patent No. 10-1814792).
Patent Document 1: Korean Patent No. 10-1814792

### SUMMARY OF THE INVENTION

However, in the technology related to secondary batteries, it is desirable to improve the electrical capacitance. In order to improve the electrical capacitance of secondary batteries, the use of lithium metal as a negative electrode active material has been studied. However, in a secondary battery using a lithium metal in which an appropriate material specification is not selected, there is a possibility that lithium metal abnormally precipitates. In order to suppress this, it is necessary to realize lithium dissolution precipitation in which short circuit does not occur even when charging and discharging are repeated and a decrease in the density of the active material layer of the negative electrode in a charged state is unlikely to occur. Therefore, it is considered that abnormal precipitation of lithium metal is suppressed by using an electrically conductive layer at a portion of the separator in contact with the surface of the lithium metal.

On the other hand, when a portion of the separator is an electrically conductive layer, it is necessary to suppress short circuit due to contact between the separator conductive layer opposite to the negative electrode, and the positive electrode, and corrosion due to contact between the separator conductive layer opposite to the negative electrode and the aluminum layer in the laminate film. This is because there is a possibility that the positive electrode and the conductive layer of the separator will come into contact with each other due to the displacement of the positive electrode, or the conductive layer of the separator will come into direct contact with the exposed aluminum layer of the laminate film depending on the lamination form. Such phenomena are more remarkable when a long continuous separator is used as in the technology disclosed in Korean Patent No. 10-1814792.

The present invention has been made in view of the above, and an object of the present invention is to provide a lithium metal secondary battery that is able to suppress short circuit in a lithium metal secondary battery using a separator having electrical conductivity.

According to the first aspect, a lithium metal secondary battery includes an electrode laminate in which positive electrodes and negative electrode containing lithium metal are laminated with a separator interposed therebetween, and an electrolytic solution, in which the separator provided between the positive electrodes and the negative electrodes is folded in zigzag manner and is continuous, the lithium metal secondary battery further includes a fixing portion that fixes the separator on an outer peripheral side of the electrode laminate, and the separator includes an electrically conductive layer having electric conductivity and an insulating layer having electrical insulation property, each of the negative electrodes being in contact with the electrically conductive layer, and each of the positive electrodes being opposed to the insulating layer.

According to the lithium metal secondary battery as described in the first aspect above, it is possible to provide a lithium metal secondary battery that is able to suppress short circuit in a lithium metal secondary battery using a separator having electrical conductivity.

According to a second aspect, in the lithium metal secondary battery as described in the first aspect, the electrode laminate is accommodated in a laminate film, and the insulating layer of the separator disposed on an outermost periphery of the electrode laminate is disposed adjacent to the laminate film.

According to the lithium metal secondary battery as described in the second aspect above, it is possible to ensure insulation between the laminate film and the electrode laminate, and it is possible to suppress short circuit.

According to a third aspect, in the lithium metal secondary battery as described in the first or second aspect above, the separator includes a folded portion that is folded back 180 degrees at any location of an outer periphery of the electrode laminate.

According to the lithium metal secondary battery as described in the third aspect, it is possible to provide the insulating layer on the outer peripheral side (the exterior body side) of the separator. With such a configuration, it is possible to ensure insulation between the exterior body and the electrode laminate, and thus it is possible to suppress short circuit.

According to a fourth aspect, in the lithium metal secondary battery as described in the third aspect, the separator is wound one or more times around the outer periphery of the electrode laminate through the folded portion.

According to the lithium metal secondary battery as described in the fourth aspect, it is possible to reliably secure insulation between the exterior body and the electrode laminate.

According to a fifth aspect, the lithium metal secondary battery as described in any of the second to fourth aspects further includes an insulating member having electrical insulation property that covers the electrode laminate on an outer peripheral side of the fixing portion and between the fixing portion and the laminate film.

According to the lithium metal secondary battery as described in the fifth aspect, the insulation between the electrode laminate and the laminate film is ensured by the insulating member. Therefore, it is possible to make the configuration of the separator more flexible.

According to a sixth aspect, in the lithium metal secondary battery as described in any one of the first to fifth aspects, the separator is wound two times or more around an outer periphery of the electrode laminate.

According to the lithium metal secondary battery as described in the sixth aspect, it is possible to obtain both the strong structure of the separator and ensuring insulation between the exterior body and the electrode laminate as advantageous effects.

### BRIEF DESCRIPTION OF THE DRAWINGS

FIG. 1 is a schematic cross-sectional view showing a lithium metal secondary battery according to an embodiment of the present invention;

FIG. 2 is a schematic cross-sectional view showing a lithium metal secondary battery according to an embodiment of the present invention;

FIG. 3 is a schematic cross-sectional view showing a lithium metal secondary battery according to an embodiment of the present invention; and

FIG. 4 is a schematic cross-sectional view showing a lithium metal secondary battery according to an embodiment of the present invention.

### DETAILED DESCRIPTION OF THE INVENTION

Hereinafter, embodiments of the present invention will be described with reference to the drawings. However, the following embodiments exemplify the present invention, and the present invention is not limited to the following embodiments.

### First Embodiment

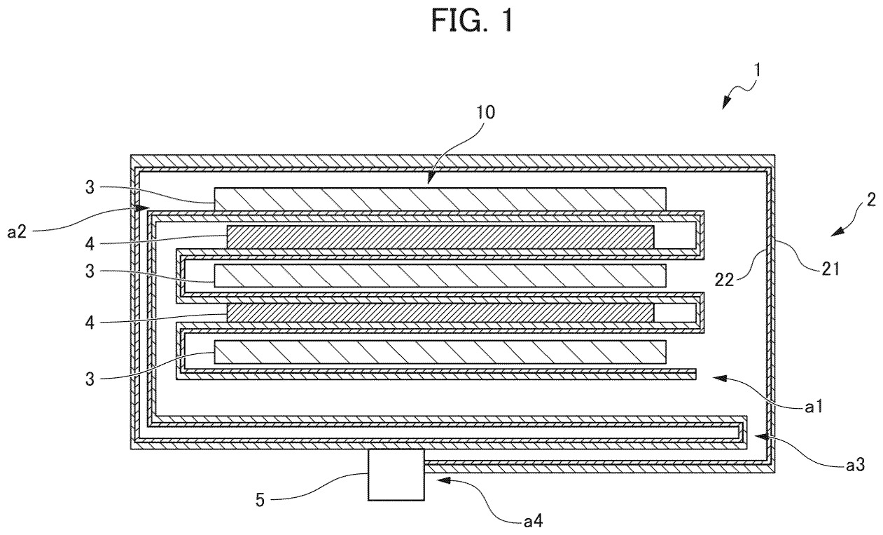

As shown in FIG. 1, a lithium metal secondary battery 1 according to a first embodiment of the present invention includes an electrode laminate 10 in which positive electrodes 4 and negative electrodes 3 containing lithium metal are laminated via a separator 2. The electrode laminate 10 is impregnated with an electrolytic solution (not shown). The electrode laminate 10 and the electrolytic solution are accommodated in an exterior body (not shown) such as a laminate film. In FIG. 1, the electrode laminate 10 includes two layers of the positive electrode 4 and three layers of the negative electrode 3; however, the number of layers of the positive electrode 4 and the negative electrode 3 is not limited to the configuration of FIG. 1.

The positive electrode 4 includes a positive electrode active material layer and a positive electrode current collector. The positive electrode current collector is connected to a positive electrode lead terminal via, for example, a positive electrode tab. The negative electrode 3 includes a negative electrode active material layer made of lithium metal as a negative electrode active material and a negative electrode current collector. The negative electrode current collector is connected to a negative electrode lead terminal via, for example, a negative electrode tab.

The positive electrode active material layer contains a positive electrode active material. Examples of the positive electrode active material include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganate (LiMn₂O₄), dissimilar element-substituted Li—Mn spinel represented by Li₁₊ₓMn_{2-x-y}M_{y}O₄ (x+y=2, M=at least one selected from Al, Mg, Co, Fe, Ni and Zn), lithium titanate (oxide containing Li and Ti), and lithium metal phosphate (LiMPO₄, and M=at least one selected from Fe, Mn, Co, and Ni). The positive electrode active material layer may contain various additives used as a material of the positive electrode active material layer, such as a binder and an electrically conductive additive.

As the material of the positive electrode current collector, for example, Al can be used. As the material of the negative electrode current collector, for example, Cu can be used.

The electrolytic solution includes an organic solvent and an electrolyte. Examples of the organic solvent include cyclic carbonates, chain carbonates, cyclic ethers, chain ethers, hydrofluoroethers, aromatic ethers, sulfones, cyclic esters, chain carboxylic acid esters, and nitriles. Examples of the cyclic carbonate include ethylene carbonate, propylene carbonate, vinylene carbonate, and fluoroethylene carbonate. Examples of the chain carbonate include dimethyl carbonate, diethyl carbonate, ethyl methyl carbonate, and the like. Examples of cyclic ethers include tetrahydrofuran, 2-methyltetrahydrofuran, tetrahydropyran, 1,3-dioxolane, 4-methyl 1,3-dioxolane, and the like. Examples of the chain ether include 1,2-dimethoxyethane, 1,2-diethoxyethane, ethoxymethoxyethane, diethyl ether, and the like. Examples of hydrofluoroethers include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl) ether, 1,2-bis(1,1,2,2-tetrafluoroethoxy)ethane, and the like. Examples of aromatic ethers include anisole. Examples of sulfones include sulfolane, methylsulfolane, and the like. Examples of cyclic esters include γ-butyrolactone and the like. Examples of the chain carboxylic acid ester include acetate, butyrate and propionate. Examples of nitriles include acetonitrile, propionitrile, and the like. The organic solvents may be used alone or in combinations of two or more.

The electrolyte is a source of lithium ions, which are charge transfer media, and includes lithium salt. Examples of lithium salt include LiPF₆, LiBF₄, LiClO₄, LiAsF₆, LiCF₃SO₃, LiC(CF₃SO₂)₃, LiN(CF₃SO₂)₂(LiTFSI), LiN(FSO₂)₂ (LiFSI), and LiBC₄O₈. The lithium salt may be used alone or in combinations of two or more kinds thereof. The concentration of the electrolyte may be, for example, in the range of 0.5 to 4.0 mol/L, in the range of 1.0 to 4.0 mol/L, or in the range of 2.0 to 4.0 mol/L.

As shown in FIG. 1, the separator 2 includes a two-layer structure including an insulating layer 21 having electrical insulation and an electrically conductive layer 22 having electric conductivity. The insulating layer 21 is disposed on one surface of the separator 2, and the electrically conductive layer 22 is disposed on the other surface of the separator 2. As the insulating layer 21, for example, a porous sheet, a nonwoven fabric sheet, or the like that is generally used as a separator of a secondary battery can be used. The electrically conductive layer 22 is formed by, for example, laminating an electrically conductive material such as a metal on the insulating layer 21 by a method such as a vapor deposition method. Examples of the material of the porous sheet include polyolefins such as polyethylene and polypropylene, aramids, polyimides, and fluororesins. Examples of the material of the nonwoven fabric sheet include glass fiber and cellulose fiber. Examples of the material of the electrically conductive layer 22 include copper (Cu), aluminum (Al), carbon, and carbon nanotubes (CNT).

The electrically conductive layer 22 is disposed so as to be in contact with the negative electrode active material layer (lithium metal) in the negative electrode 3. With the above arrangement of the electrically conductive layer 22, an electron conduction path at the time of lithium dissolution deposition is sufficiently secured, and abnormal precipitation of lithium metal is suppressed. That is, even when the lithium metal secondary battery 1 is repeatedly charged and discharged, short circuit is unlikely to occur, and a decrease in the density of the negative electrode active material layer of the negative electrode 3 in a charged state is unlikely to occur. On the other hand, the insulating layer 21 is disposed to be opposed to the positive electrodes 4 and surround the positive electrodes 4. With such a configuration, short circuit of the lithium metal secondary battery 1 is suppressed.

As shown in FIG. 1, the separator 2 is folded in zigzag manner. In the example of the electrode laminate 10 of FIG. 1, a plurality of positive electrodes 4 and a plurality of negative electrodes 3 are present, but the separator 2 is one common continuous separator. Being folded in zigzag manner indicates a structure in which a peak fold and a valley fold are alternately repeated with respect to one surface (for example, a surface on which the insulating layer 21 is formed). The electrode laminate 10 has a structure in which the positive electrodes 4 and the negative electrodes 3 are alternately laminated. Therefore, since the separator 2 common to the electrode laminate 10 is folded in zigzag manner, the electrically conductive layer 22 can be brought into contact with the negative electrodes 3, and the insulating layer 21 can be brought into contact with the positive electrodes 4. Therefore, by using a continuous separator common to the electrode laminate 10, abnormal precipitation of lithium metal in the negative electrodes 3 can be suppressed, and thus short circuit can be suppressed.

As shown in FIG. 1, the separator 2 is folded in zigzag manner so as to be disposed between the plurality of positive electrodes 4 and the plurality of negative electrodes 3 from a starting end a1 (an end, in a direction perpendicular to the stacking direction, of the negative electrode 3 located at the lamination end of the electrode laminate 10). After being disposed between all the positive electrodes 4 and the negative electrodes 3, the separator 2 is bent downward (toward the positive electrode 4) at an angle of approximately 90 degrees at a bent portion a2. With such a configuration, the insulating layer 21 can be opposed to one end portion of each of the positive electrodes 4. In addition, the other end portion of each of the positive electrodes 4 is opposed to the insulating layer 21 by the separator 2 which is folded in zigzag manner. That is, each of the positive electrodes 4 is surrounded by the insulating layer 21. With such a configuration, insulation between the positive electrodes 4 and the negative electrodes 3 is ensured, and thus short circuit can be suppressed.

The separator 2 is bent at the bent portion a2, and then wound along the outer periphery of the electrode laminate 10. A terminal a4 of the separator 2 is fixed by a fixing portion 5 on the outer peripheral side of the electrode laminate 10. The fixing portion 5 may be, for example, an adhesive tape or an adhesive. As shown in FIG. 1, the fixing portion 5 is preferably provided on the lamination surface side of the electrode laminate 10 from the viewpoint of manufacturing. This is because, in a case where the fixing portion 5 is provided on the laminated end surface side of the electrode laminate 10, since the sizes of the positive electrodes 4 and the negative electrodes 3 are different from each other, when a force is applied at the time of providing the fixing portion 5, there is a possibility that the shape and the arrangement of the positive electrodes 4 and the negative electrodes 3 are changed.

When the separator 2 is bent at the bent portion a2, and then wound along the outer periphery of the electrode laminate 10, the separator 2 preferably has a folded portion a3 that is folded 180 degrees toward the outer periphery of the electrode laminate 10 at any position. With such a configuration, the insulating layer 21 can be disposed on the outermost periphery (the exterior body side) of the separator 2. Therefore, when an exterior body having a metal such as a laminate film is used, insulation between the exterior body and the electrode laminate 10 is ensured, and thus short circuit can be suppressed. The folded portion a3 is preferably provided at a position after the insulating layer 21 is opposed to one end portion of each of all the positive electrodes 4 of the electrode laminate 10 through the bent portion a2.

The fixing portion 5 is preferably provided at a position after the insulating layer 21 is wound around the outer periphery of the electrode laminate 10 one or more times from the folded portion a3. With such a configuration, insulation between the exterior body and the electrode laminate 10 can be reliably secured.

The fixing portion 5 is preferably provided on the laminated surface of the electrode laminate 10 immediately after the insulating layer 21 is wound around the outer periphery of the electrode laminate 10 once from the folded portion a3. With such a configuration, it is possible to minimize the length of the separator 2, while suppressing short circuit between the positive electrode 4 and the negative electrode 3. Therefore, it is possible to improve the energy density of the lithium metal secondary battery 1.

The laminate film can be used as an exterior body of the lithium metal secondary battery 1. The laminate film includes, for example, an outer resin layer, a metal layer, and an inner resin layer. The configuration of each of the above-described layers is one example, and the laminate film may have, for example, a configuration in which each of the above-described layers includes a plurality of layers. Although the inner side of the laminate film is insulated by the inner resin layer, it is necessary to consider the possibility that a portion of the inner resin layer will be scraped by an external force or the like to expose the metal layer. Therefore, the configuration of the above-described embodiment is preferable in which the insulation between the laminate film and the electrode laminate 10 can be ensured by a means other than the inner resin layer.

Hereinafter, configurations of other embodiments of the present invention will be described. The same components as those of the first embodiment are denoted by the same reference numerals, and descriptions thereof may be omitted.

### Second Embodiment

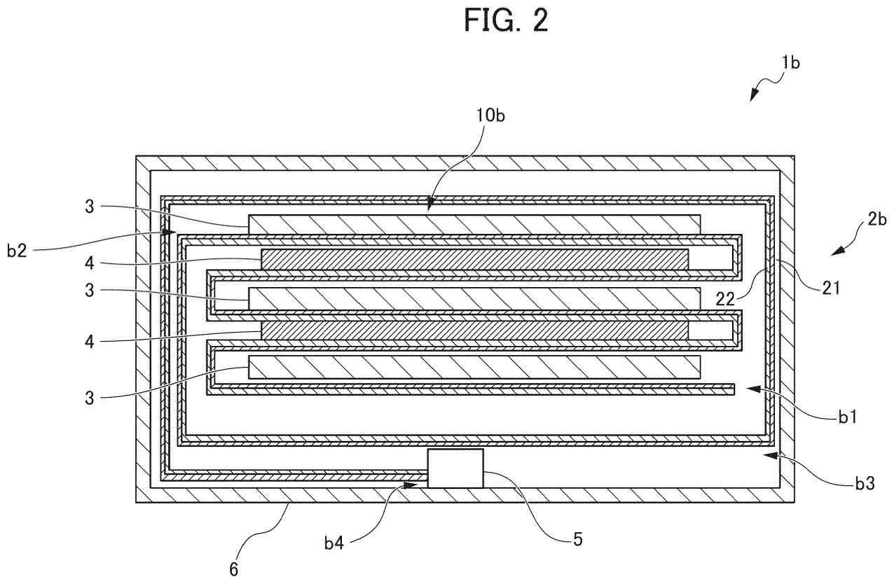

As shown in FIG. 2, a lithium metal secondary battery 1b according to the second embodiment includes an electrode laminate 10b in which positive electrodes 4 and negative electrodes 3 containing lithium metal are laminated via a separator 2b.

The lithium metal secondary battery 1b includes an insulating member 6 that covers the electrode laminate 10b on the outer peripheral side of the fixing portion 5 and between the fixing portion 5 and the exterior body (laminate film). The insulating member 6 has, for example, a sheet shape. The insulating member 6 ensures insulation between the electrode laminate 10b and the exterior body (laminate film). As an example of the material of the insulating member 6, for example, the same material as that of the insulating layer 21 can be used. In addition, an insulation tape may be used as the insulating member 6. The material of the insulation tape is not particularly limited, and examples thereof include a resin such as a polyimide film.

As shown in FIG. 2, the separator 2b is folded in zigzag manner so as to be disposed between the plurality of positive electrodes 4 and the plurality of negative electrodes 3 from a starting end b1 (an end, in the direction orthogonal to the stacking direction, of the negative electrode 3 located at the lamination end of the electrode laminate 10b). After being disposed between all the positive electrodes 4 and the negative electrodes 3, the separator 2b is bent downward (toward the positive electrode 4) at an angle of approximately 90 degrees at a bent portion b2. Thereafter, the separator 2b is bent at a bent portion b3, and then wound along the outer periphery of the electrode laminate 10b, without providing a folded portion. A terminal b4 of the separator 2b is fixed by the fixing portion 5 on the outer peripheral side of the electrode laminate 10b. As shown in FIG. 1, the fixing portion 5 is preferably provided on the laminated surface of the electrode laminate 10b from the viewpoint of manufacturing.

According to the above configuration of the lithium metal secondary battery 1b, it is possible to secure insulation between the electrode laminate 10b and the exterior body (laminate film) without providing a folded portion in the separator 2b. Therefore, it is possible to make the configuration of the separator 2b more flexible by shortening the entire length of the separator 2b or the like.

### Third Embodiment

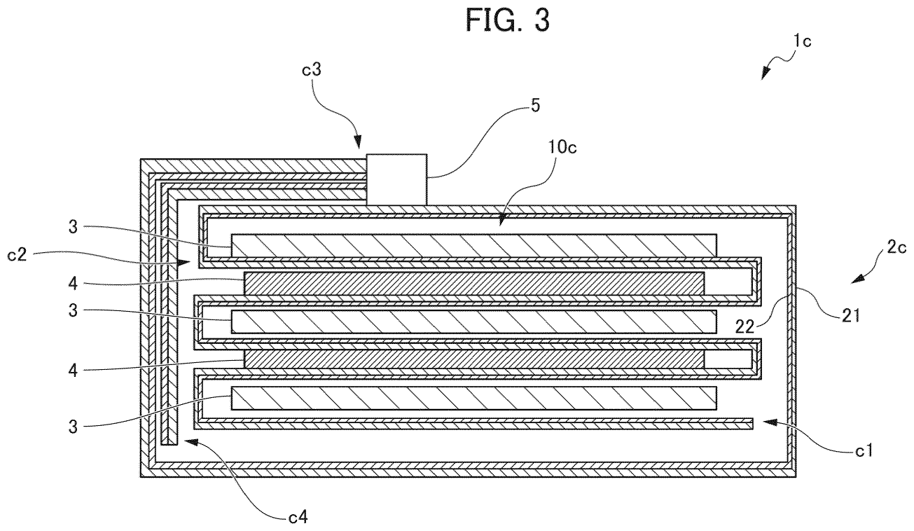

As shown in FIG. 3, a lithium metal secondary battery 1c according to the third embodiment includes an electrode laminate 10c in which positive electrodes 4 and negative electrodes 3 containing lithium metal are laminated via a separator 2c.

As shown in FIG. 3, the separator 2c is folded in zigzag manner so as to be disposed between the plurality of positive electrodes 4 and the plurality of negative electrodes 3 from a starting end c1 (an end, in the direction orthogonal to the stacking direction, of the negative electrode 3 at the lamination end of the electrode laminate 10c). After being disposed between all the positive electrodes 4 and the negative electrodes 3, the separator 2c is bent upward (toward the negative electrode 3) at an angle of approximately 90 degrees at a bent portion c2. With such a configuration, the insulating layer 21 can be disposed on the outermost periphery (the exterior body side) of the separator 2c. The separator 2c is bent at the bent portion c2, and then wound along the outer periphery of the electrode laminate 10c.

The separator 2c includes a folded portion c3 which is folded back 180 degrees to the inner peripheral side of the electrode laminate 10c on any laminate surface of the electrode laminate 10c after being bent at the bent portion c2, and then being wound around one or more times along the outer periphery of the electrode laminate 10c. The separator 2c extends to the terminal c4 through the folded portion c3. Due to the folded portion c3, the insulating layer 21c can be opposed to one end portion of each of the positive electrodes 4 (an end not opposed to the insulating layer 21 of the separator 2c which is folded in zigzag manner, of each of the positive electrodes 4). With such a configuration, it is possible to ensure insulation between the positive electrodes 4 and the negative electrodes 3, and this it is possible to suppress short circuit. In order to obtain the above advantageous effect, it is preferable to extend the separator 2c (that is, determine the position of the terminal c4) so that the insulating layer 21c is opposed to all of the one end portions of the plurality of positive electrodes 4.

The folded portion c3 is fixed by the fixing portion 5. With such a configuration, it is possible to prevent the position of the folded portion c3 from being shifted.

### Fourth Embodiment

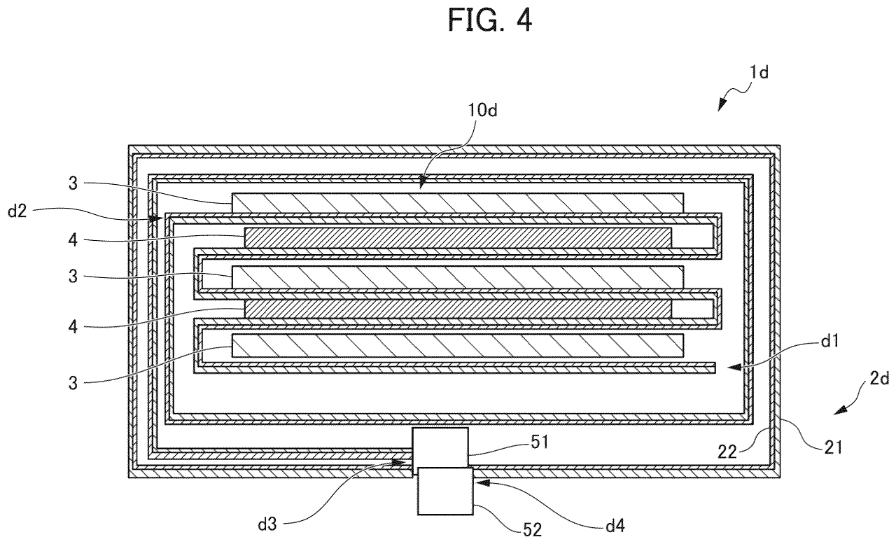

As shown in FIG. 4, a lithium metal secondary battery 1d according to the fourth embodiment includes an electrode laminate 10d in which positive electrodes 4 and negative electrodes 3 containing lithium metal are laminated via a separator 2d.

As shown in FIG. 4, the separator 2d is folded in zigzag manner so as to be disposed between the plurality of positive electrodes 4 and the plurality of negative electrodes 3 from a starting end d1 (an end, in the direction orthogonal to the stacking direction, of the negative electrode 3 at the lamination end of the electrode laminate 10d). After being disposed between all the positive electrodes 4 and the negative electrodes 3, the separator 2d is bent downward (toward the positive electrode 4) at an angle of approximately 90 degrees at a bent portion d2.

The separator 2d is bent at the bent portion d2, and then wound along the outer periphery of the electrode laminate 10d. The separator 2d is bent at the bent portion d2, then wound one or more times along the outer periphery of the electrode laminate 10d, cut at a cut portion d3, and fixed by the fixing portion 51. Thereafter, the separator 2d whose front and back faces are reversed is wound one or more times along the outer periphery of the electrode laminate 10d from the position of the cut portion d3, and a terminal d4 of the separator 2d is fixed by the fixing portion 52. With such a configuration, since the insulating layer 21 can be disposed on the outermost periphery (the exterior body side) of the separator 2d, it is possible to reliably secure insulation between the exterior body and the electrode laminate 10d.

The separator 2d is wound twice or more around the electrode laminate 10d. With such a configuration, as described above, it is possible to obtain both the strong structure of the separator 2d and ensuring insulation between the exterior body and the electrode laminate 10d as the advantageous effects.

Although preferred embodiments of the present invention have been described above, the present invention is not limited to the above-described embodiments. The above-described embodiments may be appropriately modified within the scope of the gist of the present invention.

### EXPLANATION OF REFERENCE NUMERALS

1, 1b, 1c, 1d Lithium metal secondary battery
10, 10b, 10c, 10d Electrode laminate
2, 2b, 2c, 2d Separator
21 Insulating layer
22 Electrically conductive layer
3 Negative electrode
4 Positive electrode
5, 51, 52 Fixing portion
6 Insulating member
a3 Folded portion

What is claimed is:

1. A lithium metal secondary battery comprising an electrode laminate in which positive electrodes and negative electrode containing lithium metal are laminated with a separator interposed therebetween, and an electrolytic solution, wherein
the separator disposed between the positive electrodes and the negative electrodes is folded in zigzag manner and is continuous,
the lithium metal secondary battery further includes a fixing portion that fixes the separator on an outer peripheral side of the electrode laminate, and
the separator includes an electrically conductive layer having electric conductivity and an insulating layer having electrical insulation property, each of the negative electrodes being in contact with the electrically conductive layer, and each of the positive electrodes being opposed to the insulating layer.

2. The lithium metal secondary battery according to claim 1, wherein
the electrode laminate is accommodated in a laminate film, and
the insulating layer of the separator disposed on an outermost periphery of the electrode laminate is disposed adjacent to the laminate film.

3. The lithium metal secondary battery according to claim 1, wherein the separator includes a folded portion that is folded back 180 degrees at any location of an outer periphery of the electrode laminate.

4. The lithium metal secondary battery according to claim 3, wherein the separator is wound one or more times around the outer periphery of the electrode laminate through the folded portion.

5. The lithium metal secondary battery according to claim 2, further comprising an insulating member having electrical insulation that covers the electrode laminate on an outer peripheral side of the fixing portion and between the fixing portion and the laminate film.

6. The lithium metal secondary battery according to claim 1, wherein the separator is wound two times or more around an outer periphery of the electrode laminate.
